(19) United States
(12) Patent Application Publication
(10) Pub. No.: US 2013/0273948 A1
(43) Pub. Date: Oct. 17, 2013

(54) DEVICE, SYSTEM AND METHOD OF RADIO COLLABORATION FOR WIRELESS COMMUNICATION

(71) Applicant: Avi Tel-Or, Aseret (IL)

(72) Inventor: Avi Tel-Or, Aseret (IL)

(21) Appl. No.: 13/976,091

(22) PCT Filed: Aug. 30, 2011
(86) PCT No.: PCT/US11/49795

§ 371 Date: Jun. 26, 2013

(51) Int. Cl. H04B 7/26

(52) U.S. Cl. CPC H04B 7/2603
USPC 455/500

(57) ABSTRACT

Some demonstrative embodiments include devices, systems and/or methods of radio collaboration for wireless communication. For example, a wireless communication unit may use at least one radio-frequency (RF) module of at least one other wireless communication device for wireless communication, wherein the wireless communication unit is to control the RF module via a wireless communication link between the wireless communication unit and the other wireless communication device.

### BACKGROUND

A wireless communication device may include one or more antennas to receive and/or transmit wireless communication signals over a suitable wireless communication medium.

The wireless communication device may also include a suitable analog front end including at least one transmit path to transmit signals via the antennas and/or at least one receive path to receive signals via the antennas.

The wireless communication device may also include a Radio-Frequency (RF) module (also referred to as “radio”), e.g., including a synthesizer, up converter, down converter, filter, and the like, to process analog wireless communication signals to be provided to the front end for transmission and/or to process analog signals received from the front end.

The wireless communication device may also include a base-band (BB) module to perform digital signal processing of BB signals to be transmitted by the RF module and/or signals received by the RF module.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments.

FIG. 2 is a schematic illustration of a method of radio collaboration for wireless communication, in accordance with some demonstrative embodiments.

FIG. 3 is a schematic illustration of an article of manufacture, in accordance with some demonstrative embodiments.

FIG. 4 is a schematic illustration of a first radio collaboration scheme, in accordance with some demonstrative embodiments.

FIG. 5 is a schematic illustration of a second radio collaboration scheme, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein include, for example, “multiple” or “two or more”. For example, “a plurality of items” includes two or more items.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), devices and/or networks operating in accordance with existing Wireless-Gigabit-Alliance (WGA) specifications (Wireless Gigabit Alliance, Inc WiGig MAC and PHY Specification Version 1.0, April 2010, Final specification) and/or future versions and/or derivatives thereof, devices and/or networks operating in accordance with existing IEEE 802.11 standards (IEEE 802.11-2007, IEEE Standard for Information Technology—Telecommunications and information exchange between systems—Local and metropolitan area networks—Specific requirements, Part 11: Wireless LAN Medium Access Control (MAC) and Physical Layer (PHY) Specifications; IEEE 802.11n-2009, IEEE Standard for Information Technology—Telecommunications and information exchange between systems—Local and metropolitan area networks—Specific requirements, Part 11: Wireless LAN Medium Access Control (MAC) and Physical Layer (PHY) specifications, Amendment 5: Enhancements for Higher Throughput; IEEE802.11 task group ac (TGac) (“IEEE802.11-09/0308r12—TGac Channel Model Addendum Document”), IEEE 802.11 task group ad (TGad)) (IEEE P802.11ad/D1.0 Draft Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 5: Enhancements for Very High Throughput in the 60 GHz Band), and/or future versions and/or derivatives thereof, devices and/or networks operating in accordance with existing IEEE 802.16 standards (IEEE-Std 802.16, 2009 Edition, Air Interface for Fixed Broadband Wireless Access Systems; IEEE-Std 802.16e, 2005 Edition, Physical and Medium Access Control Layers for Combined Fixed and Mobile Operation in Licensed Bands; amendment to IEEE Std 802.16-2009, developed by Task Group m) and/or future versions and/or derivatives thereof, devices and/or networks operating in accordance with existing Wireless-WirelessHD™ specifications and/or future versions and/or derivatives thereof, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, Enhanced Data rates for GSM Evolution (EDGE), or the like. Other embodiments may be used in various other devices, systems and/or networks.

The term “wireless device” as used herein includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

Some demonstrative embodiments may be used in conjunction with suitable limited-range or short-range wireless communication networks, for example, a wireless area network, a “piconet”, a WPAN, a WVAN and the like. Other embodiments may be used in conjunction with any other suitable wireless communication network.

Some demonstrative embodiments may be used in conjunction with a wireless communication network communicating over a frequency band of 60 GHz. However, other embodiments may be implemented utilizing any other suitable wireless communication frequency bands, for example, an Extremely High Frequency (EHF) band (the millimeter wave (mmwave) frequency band), e.g., a frequency band within the frequency band of between 30 Ghz and 300 GHZ, a WLAN frequency band, a WPAN frequency band, a frequency band according to the WGA specification, and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include an antenna covered by a quasi-omni antenna pattern. For example, the antenna may include at least one of a phased array antenna, a single element antenna, a set of switched beam antennas, and the like.

The phrase “quasi-omni antenna pattern”, as used herein, may include an operating mode with a widest practical beamwidth attainable for a particular antenna.

Some demonstrative embodiments include systems, devices and/or method to collaborate one or more Radio-Frequency (RF) modules between one or more wireless communication devices, e.g., as described in detail below.

In some demonstrative embodiments, the RF modules may include RF modules configured to perform wireless communication according to a suitable Wireless-Fidelity (WiFi) protocol. The WiFi protocol may include, for example, a communication protocol in accordance with the IEEE 802.11 specifications, e.g., IEEE 802.11-2007, IEEE Standard for Information Technology—Telecommunications and information exchange between systems—Local and metropolitan area networks—Specific requirements, Part 11: Wireless LAN Medium Access Control (MAC) and Physical Layer (PHY) Specifications, and/or future versions and/or derivatives thereof. In other embodiments, the RF modules may be configured in accordance with any other suitable wireless communication protocol.

In some demonstrative embodiments, at least one device of first and second wireless communication devices may share one or more internal RF module another device of the first and second wireless communication devices, e.g., for communication with at least a third wireless communication device. For example, the first wireless communication device may use an internal RF module of the second wireless communication device and/or the second wireless communication device may use an internal RF module of the first wireless communication device, e.g., as described in detail below.

In some demonstrative embodiments, a collaboration communication link may be established between the first and second wireless communication devices to allow the first wireless communication device to control the internal RF module of the second wireless communication device and/or the second wireless communication device to control the internal RF module of the first wireless communication device, e.g., as described in detail below.

In some demonstrative embodiments, the collaboration communication link may include a high-throughput and/or low-latency communication link, e.g., a 60 Gigahertz communication link. For example, the collaboration communication link may include a communication link in accordance with a high-throughput communication protocol. The high-throughput communication protocol may include a communication protocol in accordance with the IEEE 802.11TGad specification, and/or the WGA specification (Wireless Gigabit Alliance WiGig Mac and PHY specification Version 1.0, April 2010) and/or future versions and/or derivatives thereof. In other embodiments, the collaboration communication link may include any other suitable communication link.

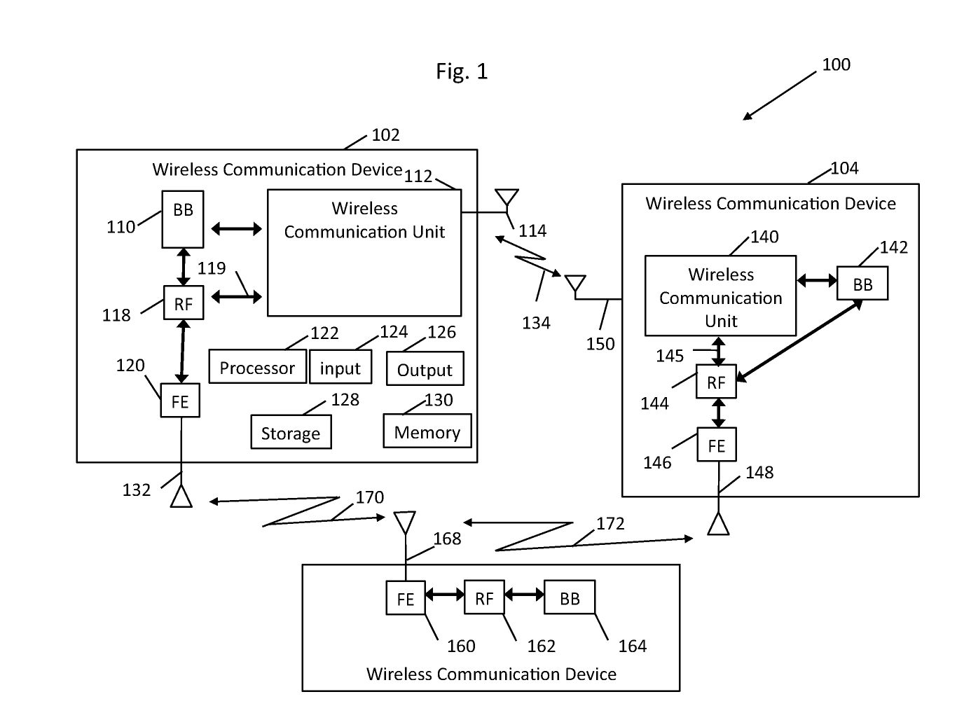

Reference is now made to FIG. 1, which schematically illustrates a block diagram of a system 100 in accordance with some demonstrative embodiments.

As shown in FIG. 1, in some demonstrative embodiments, system 100 may include a wireless communication network including one or more wireless communication devices, e.g., wireless communication devices 102, 104 and/or 106, capable of communicating content, data, information and/or signals over one or more suitable wireless communication links, for example, a radio channel, an IR channel, a RF channel, a WiFi channel, and the like. One or more elements of system 100 may optionally be capable of communicating over any suitable wired communication links.

In some demonstrative embodiments, wireless communication devices 102, 104 and/or 106 may include, for example, a PC, a desktop computer, a mobile computer, a laptop computer, a notebook computer, a tablet computer, a server computer, a handheld computer, a handheld device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative embodiments, wireless communication devices 102, 104 and/or 106 may include any suitable components for communicating wireless communication signals over one or more wireless communication links.

For example, wireless communication device 102 may include, or may be associated with, one or more antennas 132; wireless communication device 104 may include, or may be associated with, one or more antennas 148; and/or wireless communication device 106 may include, or may be associated with, one or more antennas 168. Antennas 132, 148 and/or 168 may include any type of antennas suitable for transmitting and/or receiving wireless communication signals, blocks, frames, transmission streams, packets, messages and/or data. For example, antennas 132, 148 and/or 168 may include any suitable configuration, structure and/or arrangement of one or more antenna elements, components, units, assemblies and/or arrays. Antennas 132, 148 and/or 168 may include an antenna covered by a quasi-omni antenna pattern. For example, antennas 132, 148 and/or 168 may include at least one of a phased array antenna, a single element antenna, a set of switched beam antennas, and the like. In some embodiments, antennas 132, 148 and/or 168 may implement transmit and receive functionalities using separate transmit and receive antenna elements. In some embodiments, antennas 132, 148 and/or 168 may implement transmit and receive functionalities using common and/or integrated transmit/receive elements.

In some demonstrative embodiments, wireless communication devices 102, 104 and/or 106 may include an analog Front-End (FE). For example, wireless communication device 102 may include a FE 120, wireless communication device 104 may include a FE 146 and/or wireless communication device 106 may include a FE 160. Front ends 120, 146 and/or 160 may include any suitable FE elements, e.g., one or more suitable power amplifiers and/or filters, forming at least one suitable transmit path and/or at least one suitable receive path.

In some demonstrative embodiments, wireless communication devices 102, 104 and/or 106 may include an internal Radio-Frequency (RF) module (also referred to as “radio”). For example, wireless communication device 102 may include a RF module 118, wireless communication device 104 may include a RF module 144 and/or wireless communication device 106 may include a RF module 162. RF modules 118, 144 and/or 162 may include any suitable RF transmitter and/or receiver elements, e.g., any suitable synthesizer, up converter, down converter, filter, and the like, to process analog wireless communication signals for transmission and/or to process received analog wireless communication signals.

In some demonstrative embodiments, RF modules 118, 144 and/or 162 may be configured to perform wireless communication according to a suitable WiFi protocol, e.g., the IEEE 802.11 specifications. In other embodiments, RF modules 118, 144 and/or 162 may be configured in accordance with any other suitable wireless communication protocol.

In some demonstrative embodiments, wireless communication devices 102, 104 and/or 106 may include a suitable Base-Band (BB) module. For example, wireless communication device 102 may include a BB module 110, wireless communication device 104 may include a BB module 142 and/or wireless communication device 106 may include a BB module 164. BB modules 110, 142 and/or 164 may include any suitable BB elements to perform digital signal processing of BB signals to be transmitted by RF modules 118, 144 and/or 162 and/or signals received by RF modules 118, 144 and/or 162.

In some demonstrative embodiments include systems, one or more wireless communication devices of system 100 may share and/or collaborate one or more RF modules, e.g., as described in detail below.

In some demonstrative embodiments, wireless communication devices 102 and 104 may share RF modules 118 and/or 144, e.g., for communication with wireless communication device 106 and/or with one or more other wireless communication device. For example, wireless communication device 102 may use internal RF module 144 of wireless communication device 104 and/or wireless communication device 104 may use internal RF module 118 of wireless communication device 102, e.g., as described in detail below.

In some demonstrative embodiments, wireless communication devices 102 and 104 may establish a collaboration communication link 134 to allow wireless communication device 102 to control RF module 144 of wireless communication device 104 and/or to allow wireless communication device 104 to control RF module 118 of wireless communication device 102, e.g., as described in detail below.

In some demonstrative embodiments, collaboration communication link 134 may include a high-throughput communication link, e.g., a 60 Gigahertz communication link. For example, collaboration communication link 134 may include a communication link in accordance with the high-throughput protocols and/or future versions and/or derivatives thereof In other embodiments, collaboration communication link 134 may include any other suitable communication link.

In some demonstrative embodiments, wireless communication devices 102 and/or 104 may include wireless communication units 112 and/or 140, respectively, to perform wireless communication over link 134, e.g., as described below.

In some demonstrative embodiments, wireless communication module 112 may include, or may be associated with, one or more antennas 114 and/or wireless communication module 140 may include, or may be associated with, one or more antennas 150. Antennas 114 and/or 150 may include any type of antennas suitable for transmitting and/or receiving wireless communication signals, blocks, frames, transmission streams, packets, messages and/or data. For example, antennas 114 and/or 150 may include any suitable configuration, structure and/or arrangement of one or more antenna elements, components, units, assemblies and/or arrays. In one example, antennas 114 and/or 150 may include an antenna covered by a quasi-omni antenna pattern. For example, antennas 114 and/or 150 may include at least one of a phased array antenna, a single element antenna, a set of switched beam antennas, and the like. In some embodiments, antennas 114 and/or 150 may implement transmit and receive functionalities using separate transmit and receive antenna elements. In some embodiments, antennas 114 and/or 150 may implement transmit and receive functionalities using common and/or integrated transmit/receive elements.

In some demonstrative embodiments, wireless communication modules 112 and/or 140 include, for example, one or more wireless transmitters, receivers and/or transceivers able to send and/or receive wireless communication signals, frames, blocks, transmission streams, packets, messages, data items, and/or data. For example, wireless communication modules 112 and/or 140 may include or may be implemented as part of a wireless Network Interface Card (NIC), and the like.

In some demonstrative embodiments, wireless communication device 102 may include a digital RF interface 119 connecting between wireless communication unit 112 and RF module 118. Digital RF interface 119 may allow transferring digital signals, e.g., digital BB signals, between wireless communication unit 112 and RF module 118.

In some demonstrative embodiments, wireless communication device 104 may include a digital RF interface 145 connecting between wireless communication unit 140 and RF module 144. Digital RF interface 145 may allow transferring digital signals, e.g., digital BB signals, between wireless communication unit 140 and RF module 144.

Digital RF interfaces 119 and/or 145 may include, for example, an interface according to the DigRF specifications, e.g., the specifications DigRF 3G, 2006, and/or DigRF v4, April 2010 and/or future versions and/or derivatives thereof.

Wireless communication devices 102, 104 and/or 106 may also include, for example, one or more of a processor 122, an input unit 124, an output unit 126, a memory unit 130, and a storage unit 132. Wireless communication devices 102, 104 and/or 106 may optionally include other suitable hardware components and/or software components. In some demonstrative embodiments, some or all of the components of one or more of wireless communication devices 102, 104 and/or 106 may be enclosed in a common housing or packaging, and may be interconnected or operably associated using one or more wired or wireless links. In other embodiments, components of one or more of wireless communication devices 102, 104 and/or 106 may be distributed among multiple or separate devices.

Processor 122 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 122 executes instructions, for example, of an Operating System (OS) of wireless communication device 102 and/or of one or more suitable applications.

Input unit 124 includes, for example, a keyboard, a keypad, a mouse, a touch-pad, a track-ball, a stylus, a microphone, or other suitable pointing device or input device. Output unit 126 includes, for example, a monitor, a screen, a flat panel display, a Cathode Ray Tube (CRT) display unit, a Liquid Crystal Display (LCD) display unit, a plasma display unit, one or more audio speakers or earphones, or other suitable output devices.

Memory unit 130 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 128 includes, for example, a hard disk drive, a floppy disk drive, a Compact Disk (CD) drive, a CD-ROM drive, a DVD drive, or other suitable removable or non-removable storage units. Memory unit 130 and/or storage unit 128, for example, may store data processed by wireless communication device 102.

In some demonstrative embodiments, wireless communication device 102 may collaboratively use RF module 144 of wireless communication device 104 for wireless communication of wireless communication device 102; and/or wireless communication device 104 may collaboratively use RF module 118 of wireless communication device 102 for wireless communication of wireless communication device 104. For example, wireless communication device 102 may control RF module 144 and/or wireless communication device 104 may control RF module 118 via collaboration link 134 between wireless communication units 112 and 140, e.g., as described in detail below.

In some demonstrative embodiments, wireless communication unit 112 may use RF module 144 of wireless communication device 104, for example, for communicating between wireless communication devices 102 and 106, e.g., using a wireless communication link 172 between RF modules 144 and 160; and/or wireless communication unit 140 may use RF module 118 of wireless communication device 102, for example, for communicating between wireless communication devices 104 and 106, e.g., using a wireless communication link 170 between RF modules 118 and 160.

In some demonstrative embodiments, collaboration of an RF module, e.g., RF module 118 and/or RF module 144, for use by two or more wireless communication devices, e.g., wireless communication devices 102 and 104, may improve performance, e.g., in terms of throughput, bandwidth utilization, wireless communication range, connection reliability, battery utilization, power consumption, and the like, of one or more wireless communication devices of system 100, e.g., devices 102, 104 and/or 106.

In one example, a communication range of wireless communication device 102 may be lesser than a communication range of wireless communication device 104, e.g., a WiFi communication range of RF module 118 may be lesser than a WiFi communication range of RF module 144. For example, wireless communication device 102 may include a Smartphone and/or wireless communication device 104 may include a notebook computer. Wireless communication device 106 may be, for example, out of the WiFi communication range of RF module 118, and/or located closer to wireless communication device 104.

In another example, wireless communication device 102 may have a reduced battery level compared to a battery level of wireless communication device 104. For example, wireless communication device 102 may be operating at a relatively low battery level, while wireless communication device 104 may be operating at a substantially full battery level. According to this example, wireless communication device 102 may utilize RF module 144 of wireless communication device 104, e.g., instead of utilizing internal RF module 118 of device 102, for communicating with wireless communication device 106, while reducing the power consumed by wireless communication device 102.

In another example, a reliability and/or communication quality of wireless communication link 170 may be lesser than a reliability and/or communication quality of wireless communication link 172. According to this example, wireless communication device 102 may utilize RF module 144 of wireless communication device 104, e.g., instead of utilizing internal RF module 118 of device 102, for communicating with wireless communication device 106, e.g., while utilizing the increased reliability and/or communication quality of wireless communication link 172.

In some demonstrative embodiments, wireless communication units 112 and 140 may connect between BB module 110 and RF module 144 via collaboration link 134, such that, for example, BB module 110 may use RF module 144, e.g., to perform wireless communication with wireless communication device 106. For example, BB module 110 may control RF module 144 via collaboration link 134.

In some demonstrative embodiments, wireless communication units 112 and 140 may connect between BB module 142 and RF module 118 via collaboration link 134, such that, for example, BB module 142 may use RF module 118, e.g., to perform wireless communication with wireless communication device 106. For example, BB module 142 may control RF module 118 via collaboration link 134

In some demonstrative embodiments, BB module 110 may provide wireless communication unit 112 with digital BB signals to be transmitted by RF module 144 of device 104, and wireless communication unit 112 may transmit the digital BB signals to wireless communication unit 140 via collaboration link 134. Wireless communication unit 140 may control RF module 144, e.g., vie link 172, to transmit a transmission based on the BB signals from BB module 110.

In some demonstrative embodiments, BB module 142 may provide wireless communication unit 140 with digital BB signals to be transmitted by RF module 118 of device 102, and wireless communication unit 140 may transmit the digital BB signals to wireless communication unit 112 via collaboration link 134. Wireless communication unit 112 may control RF module 118 to transmit a transmission, e.g., vie link 170, based on the BB signals from BB module 142.

In some demonstrative embodiments, RF module 144 may receive from device 106 digital BB signals generated by BB module 164 and intended for wireless communication device 102. RF module 144 may provide the BB signals to wireless communication unit 140, which may transmit the BB signals to wireless communication unit 112 via collaboration link 134. Wireless communication unit 112 may provide the BB signals to BB module 110.

In some demonstrative embodiments, RF module 118 may receive from device 106 digital BB signals generated by BB module 164 and intended for wireless communication device 104. RF module 118 may provide the BB signals to wireless communication unit 112, which may transmit the BB signals to wireless communication unit 140 via collaboration link 134. Wireless communication unit 140 may provide the BB signals to BB module 142.

In some demonstrative embodiments, collaboration of an RF module, e.g., RF module 118 and/or RF module 144, for use by two or more wireless communication devices, e.g., wireless communication devices 102 and 104, may be performed automatically, for example, based on any suitable criteria, e.g., configured by a user of device 102 and/or 104. For example, wireless communication device 102 may automatically connect to and/or use RF module 144 of wireless communication device 104, e.g., based on detecting wireless communication device 104, a battery level of wireless communication devices 102 and/or 104, a relative location and/or distance between wireless communication devices 102, 104, 106, and/or any other suitable criterion.

In some demonstrative embodiments, collaboration of an RF module, e.g., RF module 118 and/or RF module 144, for use by two or more wireless communication devices, e.g., wireless communication devices 102 and 104, may be performed manually. For example, a user of wireless communication device 102 may use any suitable interface to manually cause wireless communication device 102 to connect to and/or use RF module 144 of wireless communication device 104.

In some demonstrative embodiments, a first wireless communication device (“the master”) may initiate a collaboration session for collaboration of at least one RF module with a second wireless communication device (“the slave”). For example, the BB module of the master device may initiate the collaboration session for using the RF module of the slave device. The initiation of the collaboration session may include, for example, setting up a collaboration link, e.g., link 134, between the master and slave devices, exchanging information relating to the RF module of the slave device, e.g., supported modes, calibration data, and the like, and/or any suitable operations to enable the master device to control the RF module of the slave device via a wireless collaboration link. For example, wireless communication devices 102 and 104 may initiate the collaboration session according to a predefined initiation protocol, which may be implemented, for example, by the BB module of the master device and the RF module of the slave device, by the BB module of the master device and the wireless communication unit of the slave device, by the wireless communication unit of the master device the wireless communication unit of the slave device, and/or by any other suitable communication layer of system 100. The initiation protocol may include, for example, one or more of scanning and discovery of the slave device by the master device; exchanging of information regarding capabilities of the master device and/or the slave device to support and/or select one or more RF-related attributes, e.g., frequency, transmit power, number of antennas to be used, antenna gain, regulatory approvals/limitations of use, and the like; negotiating ‘terms of use’ with respect utilization of the RF module of the slave device, e.g., not more than a predefined percentage, % X, duty cycle, ending within a suitable time period, Y minutes, from now, at transmit power not exceeding a predefined value, Z, and the like; pairing between the master and slave devices; operational configuration data exchange; time synchronization ; and any other suitable operation for initiating the collaboration session.

In some demonstrative embodiments, the BB module of the master device, e.g., BB module 110 of device 102, may control the RF module of the slave device, e.g., RF module 144 of device 104. For example, BB module 110 may configure RF module 144, calibrate RF module 144 and/or control RF module 144 in any other suitable manner, e.g., similar to a manner in which BB module 110 may control internal RF module 118, to enable RF module 144 to communicate date received from, and/or to b transferred to, BB module 110.

In some demonstrative embodiments, during the collaboration session the BB module of the master device may communicate with the RF module (“the connected radio”) of the slave device. For example, during the collaboration session, BB module 110 may transfer signals, e.g., including data signals and/or control signals, to RF module 144, e.g., via wireless communication unit 112 and link 134. BB module 110 may receive from RF module 144 signals, e.g., data signals and/or feedback signals, for example, via wireless communication unit 112 and link 134.

In some demonstrative embodiments, the collaboration session may be terminated by one of the slave and master devices, for example, using a suitable session-termination indication, e.g., by transmitting a termination message over collaboration link 134. In one example, the slave device may provide a termination indication to the master device, e.g., via collaboration link 134, at least a predefined time period prior to terminating the collaboration session, e.g., in order to allow the BB module of the master device to switch to using another RF module.

In some demonstrative embodiments, one or more RF modules of devices 102 and 104 may be used, in collaboration, between BB modules of devices 102 and 104 according to one or more suitable collaboration schemes, e.g., as described below.

In some demonstrative embodiments, a BB module may be connected to a plurality of RF modules, e.g., including one or more internal RF modules co-located with the BB module within a common wireless communication device, and one or more external RF modules of other wireless communication devices. For example, BB module 110 may be connected to both internal RF module 118 of device 102 as well as RF module 144 of device 104.

In one embodiment, the BB module may utilize the connected RF modules according to an aggregative collaboration scheme. For example, the BB module may combinely and/or simultaneously control the two or more of the connected RF modules to perform wireless communication according to a suitable multi-radio communication scheme, e.g., a multi-carrier communication scheme, a multi-input-multi-output (MIMO) scheme, a maximal-ratio-combining (MRC) scheme, and the like. In one example, BB module 110 may be configured to simultaneously use both RF module 144 of device 104 and internal RF module 118 of device 102 for wireless communication, e.g., with wireless communication device 106 and/or one or more other wireless communication devices. For example, BB module 110 may utilize both RF module 118 and RF module to perform a suitable multi-radio communication with device 106 over a combined communication link.

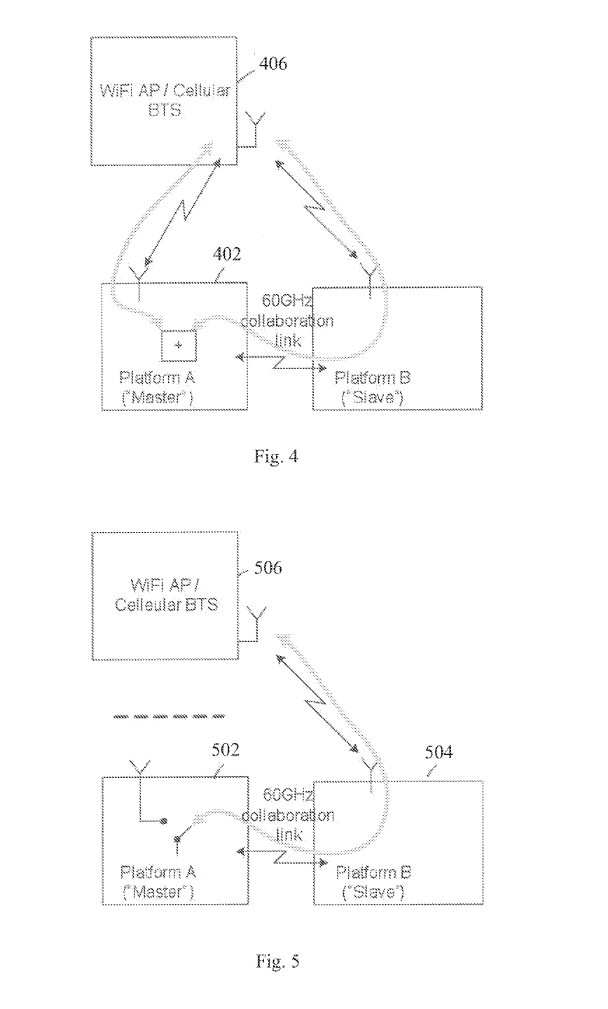

FIG. 4 schematically illustrates an aggregative radio collaboration scheme, in accordance with some demonstrative embodiments. As shown in FIG. 4, a master device 402 may utilize a slave device 404 to communicate with another device 406. According to the aggregative radio collaboration scheme of FIG. 4, device 402 may combinely and/or simultaneously utilize both an internal RF module of device 402 and a RF module of device 404 for communicating with device 406.

In another embodiment, the BB module may utilize the connected RF modules according to a selective collaboration scheme. For example, the BB module may selectively use one or more of the connected RF modules, at a given time, for wireless communication. In one example, BB module 110 may select between RF module 118 of device 102 and RF module 144 of device 104 for wireless communication, e.g., for receiving wireless communication signals from device 106 and/or for transmitting wireless communication signals to device 106 and/or one or more other wireless communication devices. For example, BB module 110 may select between using RF module 118 to communicate with device 106 over link 170, and using RF module 144 to communicate with device 106 over link 172.

FIG. 5 schematically illustrates a selective radio collaboration scheme, in accordance with some demonstrative embodiments. As shown in FIG. 5, a master device 503 may utilize a slave device 504 to communicate with another device 506. According to the selective radio collaboration scheme of FIG. 5, device 502 may select to utilize a RF module of device 504 for communicating with device 506, e.g., instead of using an internal RF module of device 502 and/or if device 502 does not include an internal RF module.

In another embodiment, the BB module may utilize the connected RF modules according to a combined selective/aggregative collaboration scheme. For example, the BB module may selectively use only some of the connected RF modules to communicate according to the aggregation scheme.

In some demonstrative embodiments, one or more of the collaboration schemes, as described above, may be implemented in accordance with various use cases, for example, to increase and/or optimize data rate transfer, e.g., utilizing MIMO and/or or multicarrier aggregation communication schemes, higher aggregated transmit power, e.g., not limited by transmit limitations of a single platform, and/or lower power consumption, e.g., by signal combining and/or by selection of the RF module associated with an improved, or best, communication channel.

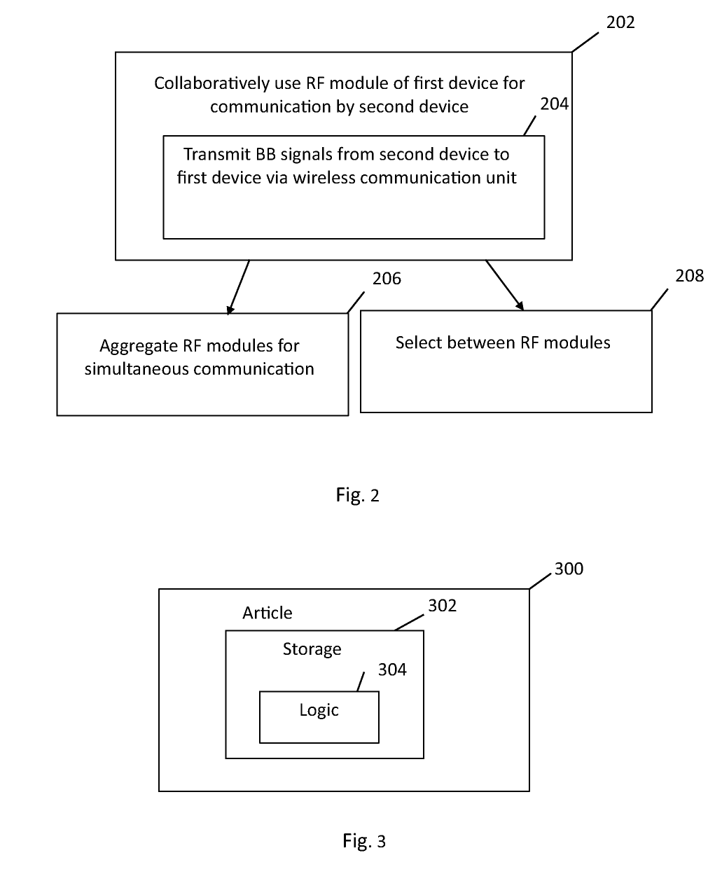

Reference is made to FIG. 2, which schematically illustrates a method of radio collaboration for wireless communication, in accordance with some demonstrative embodiments. In some embodiments, one or more of the operations of the method of FIG. 2 may be performed by any suitable wireless communication system e.g., system 100 (FIG. 1); and/or wireless communication device, e.g., devices 102, 104 and/or 106 (FIG. 1).

As indicated at block 202, the method may include collaboratively using at least one RF module of at least one first wireless communication device for wireless communication of at least one second wireless communication device, for example, by controlling the RF module at the second wireless communication device via a wireless communication link between the first and second wireless communication devices. For example, wireless communication device 102 (FIG. 1) may collaboratively use RF module 144 (FIG. 1) of wireless communication device 104 (FIG. 1) for wireless communication, for example, by controlling RF module 144 (FIG. 1) via wireless communication link 134 (FIG. 1), e.g., as described above.

As indicated at block 204, the controlling may include transmitting BB signals from the second wireless communication device to the first wireless communication device via the wireless communication link. For example, wireless communication device 102 (FIG. 1) may transmit transmitting BB signals wireless communication device 104 (FIG. 1) via wireless communication link 134 (FIG. 1), e.g., as described above. In other embodiments, the controlling may include transmitting control signals of any other suitable format, e.g., Intermediate Frequency (IF) signals, from the second wireless communication device to the first wireless communication device via the wireless communication link.

As indicated at block 206, the method may include simultaneously using both the RF module of the first wireless communication device and an RF module of the second wireless communication device for the wireless communication of the second wireless communication device. For example, BB module 110 (FIG. 1) may simultaneously use both RF module 144 (FIG. 1) and internal RF module 118 (FIG. 1) for wireless communication, e.g., with wireless communication device 106 (FIG. 1), e.g., as described above.

As indicated at block 208, the method may include selecting between the RF module of the first wireless communication device and the RF module of the second wireless communication device for the wireless communication of the second wireless communication device. For example, BB module 110 (FIG. 1) may select between RF module 118 (FIG. 1) and RF module 144 (FIG. 1) for wireless communication with wireless communication device 106 (FIG. 1), e.g., as described above.

Reference is made to FIG. 3, which schematically illustrates an article of manufacture 300, in accordance with some demonstrative embodiments. Article 300 may include a machine-readable storage medium 302 to store logic 304, which may be used, for example, to perform at least part of the functionality of BB 110 and/or 142 (FIG. 1), wireless communication unit 112 and/or 140 (FIG. 1), wireless communication device 102 and/or 104 (FIG. 1), and/or to perform one or more operations of the method of FIG. 2.

In some demonstrative embodiments, article 300 and/or machine-readable storage medium 302 may include one or more types of computer-readable storage media capable of storing data, including volatile memory, non-volatile memory, removable or non-removable memory, erasable or non-erasable memory, writeable or re-writeable memory, and the like. For example, machine-readable storage medium 302 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 304 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 304 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A wireless communication device comprising:
a wireless communication unit to use at least one radio-frequency (RF) module of at least one other wireless communication device for wireless communication, wherein said wireless communication unit is to control said RF module via a wireless communication link between said wireless communication unit and said other wireless communication device.

2. The wireless communication device of claim 1 comprising:
an internal baseband (BB) module,
wherein said wireless communication unit is to connect between said internal BB module and said RF module via said wireless communication link.

3. The wireless communication device of claim 2 comprising an internal RF module.

4. The wireless communication device of claim 3, wherein said internal BB module is configured to simultaneously use both the RF module of the other device and said internal RF module for said wireless communication.

5. The wireless communication device of claim 3, wherein said internal BB module is configured to select between at least one of the RF module of the other device and said internal RF module for said wireless communication.

6. The wireless communication device of claim 3, wherein said wireless communication device is to share said internal RF module with at least one external device by allowing said external device to control said internal RF module via a wireless communication link between said wireless communication unit and said external device.

7. The wireless communication device of claim 3, wherein said internal BB module is to provide said wireless communication unit with digital BB signals to be transmitted by the RF module of the other device module, and wherein said wireless communication unit is to transmit said digital BB signals to said other wireless communication device via the wireless communication link between said wireless communication unit and said external device.

8. The wireless communication device of claim 1 comprising one or ore antennas associated with said wireless communication unit.

9. The wireless communication device of claim 1, wherein said wireless communication link comprises a high-throughput communication link.

10. The wireless communication device of claim 9, wherein said high-throughput communication link comprises a 60 Gigahertz communication link.

11. A wireless communication device comprising:
an internal radio-frequency (RF) module; and
a wireless communication unit to share said internal RF module for communication between at least one first other wireless communication device and at least one second other wireless communication device by connecting said first other wireless communication device to said internal RF module via a wireless communication link between said wireless communication unit and said first other wireless communication device.

12. The wireless communication device of claim 11, wherein said wireless communication unit is to receive digital baseband (BB) signals over said wireless communication link and to control said internal RF module to transmit a transmission based on said digital BB signals.

13. The wireless communication device of claim 12 comprising a digital RF interface connecting said wireless communication unit to said internal RF module.

14. The wireless communication device of claim 11 comprising:
an internal baseband (BB) module to provide said internal RF module with digital signals to be transmitted by said RF module.

15. The wireless communication device of claim 11, wherein said wireless communication unit to use at least one external RF module of at least one external device for wireless communication, wherein said wireless communication unit is to control said external RF module via a wireless communication link between said wireless communication unit and said external device.

16. The wireless communication device of claim 15 comprising:
an internal baseband (BB) module,
wherein said wireless communication unit is to connect between said internal BB module and said external RF module via the wireless communication link between said wireless communication unit and said external device.

17. The wireless communication device of claim 11 comprising one or more antennas associated with at least one of said internal RF module and said wireless communication unit.

18. The wireless communication device of claim 11, wherein said wireless communication link comprises a high-throughput communication link.

19. A method of wireless communication, said method comprising:
collaboratively using at least one radio-frequency (RF) module of at least one first wireless communication device for wireless communication of at least one second wireless communication device by controlling said RF module at said second wireless communication device via a wireless communication link between said first and second wireless communication devices.

20. The method of claim 19, wherein said controlling comprises transmitting baseband (BB) signals from said second wireless communication device to said first wireless communication device via said wireless communication link.

21. The method of claim 19 comprising simultaneously using both the RF module of said first wireless communication device and an RF module of said second wireless communication device for the wireless communication of said second wireless communication device.

22. The method of claim 19 comprising selecting between the RF module of said first wireless communication device and an RF module of said second wireless communication device for the wireless communication of said second wireless communication device.

23. The method of claim 19, wherein said wireless communication link comprises a high-throughput communication link.

24. A wireless communication system comprising:
a first wireless communication device including a radio-frequency (RF) module; and
a second wireless communication device to establish a wireless collaboration link with said first wireless communication device and to use the RF module of said first wireless communication device for wireless communication by controlling said RF module via said wireless collaboration link.

25. The system of claim 24, wherein said second wireless communication device is to transmit over said wireless collaboration link baseband signals to control said RF module.

26. The system of claim 24, wherein said second wireless device comprises an internal RF module.

27. The system of claim 26, wherein said second wireless communication device is to simultaneously use both the RF module of said first wireless communication device and said internal RF module for the wireless communication of said second wireless communication device.

28. The system of claim 26, wherein said second wireless communication device is to select between the RF module of said first wireless communication device and said internal RF module for the wireless communication of said second wireless communication device.

29. The system of claim 24, wherein said wireless collaboration link comprises a high-throughput communication link.
